(19) United States
(12) Patent Application Publication
(10) Pub. No.: US 2006/0056572 A1
(43) Pub. Date: Mar. 16, 2006

(54) Method and device for the production of electricity from the heat produced in the core of at least one high temperature nuclear reactor

(75) Inventor: Michel Lecomte, Rueil Malmaison (FR)

Correspondence Address: CONNOLLY BOVE LODGE & HUTZ LLP, SUITE 800, 1990 M STREET NW, WASHINGTON, DC, 20036-3425, US

(73) Assignee: Framatome ANP, Courbevoie (FR)

(21) Appl. No.: 10/510,599

(22) PCT Filed: Apr. 7, 2003
(86) PCT No.: PCT/FR03/01091

§ 371 Date: Mar. 18, 2005

(30) Foreign Application Priority Data
Apr. 12, 2002 (FR) 02/04638

(51) Int. Cl. G21C 19/28

(52) U.S. Cl. 376/383

(57) ABSTRACT

A first coolant gas in contact with the core (5) of the high temperature nuclear reactor (1) is circulated in a closed circuit, a second heat-exchange gas is heated by heat-exchange with the first exchange gas or coolant gas and the second heat-exchange gas heated by the first coolant gas is used in an intermediate exchanger (7) to drive at least one gas turbine (2) coupled to an electric generator (4). The first exchange gas consists mainly of helium and the second exchange gas contains substantially 50 to 70% by volume of helium and 50 to 30% by volume of nitrogen. The second heat-exchange gas is circulated in a closed circuit so that the second heat-exchange gas at least drives the at least one gas turbine (2). Preferably, the device also comprises a tertiary circuit (10) in which there circulates water and steam formed by heating water from a fraction of the second exchange fluid and used to drive steam turbines (3a, 3b, 3c) preferably mounted on the shaft of the electric generator (4).

The invention relates to a method and a device for producing electricity from the heat produced in the core of at least one nuclear reactor and, in particular, of a high temperature nuclear reactor.

Nuclear reactors of which the coolant fluid, in the operating nuclear reactor, is at a high temperature (for example higher than 800° C.) in comparison with the temperature of the coolant of electricity producing reactors such as PWR reactors of which the coolant is at a temperature of approximately 320° C.

High temperature reactors of this type are cooled by a coolant fluid which is generally a gas such as helium which has very good heat-exchange characteristics and is totally inert.

At the outlet of the nuclear reactor core, the coolant gas is at a temperature substantially equal to the temperature of the core, for example at a temperature of 850° C.

It has been proposed in some methods of producing electricity to use the helium heated in contact with the nuclear reactor core directly to drive a gas turbine coupled to an electricity generator such as an alternator.

The helium used to drive the gas turbine has, at the turbine outlet, a pressure which is substantially lower than the pressure of the coolant helium used for cooling the nuclear reactor core. The helium recovered at the outlet of the turbine therefore has to be recompressed before being conveyed to the interior of the nuclear reactor vessel to cool the core. It is therefore necessary to use a plurality of low-pressure and high-pressure compressor stages to recompress the helium recovered at the outlet of the turbine before conveying it into the nuclear reactor vessel in contact with the core. Preferably, heat exchangers must also be combined with the helium compression stages to adjust the temperature of the helium so as to make the compressors operate with acceptable energy yields.

In such installations, the compressors which are driven by the turbine shaft consume a significant amount of energy which may not be transformed into electricity by the alternator, so the overall yield of the installation is reduced by the same amount.

In addition, a device of this type for producing electricity from the heat produced in the core of a direct cycle high temperature nuclear reactor and employing helium as the coolant gas has to operate in a completely closed circuit and the losses of helium on the closed circuit of the electricity producing device have to be limited as far as possible.

It is necessary to design a turbine and compressors of specific unconventional technology since the gas for driving the turbine, which is recompressed in the compression stages, is a light gas having a pronounced diffusion capacity. It is necessary to design bearings and gaskets of a particular type and heat exchangers which allow the temperature at the inlet of the compressor stages to be lowered to improve the energy yield of these compressors.

In general, all the elements used and, in particular, the turbine and the compressors have to be engineered and designed specifically for use in a direct cycle with helium as the working gas.

The further removed from conventional methods of using gas turbines, the more expensive the engineering and design of the various elements and, in particular, of the turbines and compressors.

In addition, the helium which is used to drive the turbine and is recompressed in the compressors constitutes the primary coolant fluid and comes into contact with the nuclear reactor core elements, such that it is likely to be loaded with products exhibiting a certain degree of activity. The turbine, the compressors, the heat exchangers and the electric generator have to be disposed inside a sealed chamber which is disposed in the region of the nuclear reactor vessel so as to allow the passage of the coolant helium originating from the nuclear reactor core or conveyed into the core and thus to restrict the activity.

Devices for producing electricity from a helium-cooled high temperature nuclear reactor have been proposed in which the turbine is not driven by a gas capable of containing elements which are activated in contact with the core. An intermediate exchanger between the coolant helium circulating in a closed circuit in contact with the nuclear reactor core and the secondary helium also circulating in a closed circuit and driving the gas turbine are used for this purpose. However, the drawbacks relating to the design of the turbine and of the compressors as well as the other elements of the secondary portion of the device remain in such a dual-fluid cycle employing primary helium and secondary helium since the secondary fluid consists of helium. In addition, it is necessary to design an intermediate exchanger in which there circulate the primary fluid and the secondary fluid which both consist of helium.

Installations for producing electric energy comprising a gas turbine which is driven by air at a very high temperature and a high pressure are also known.

The air at a very high temperature and a high pressure, which drives the turbine, is produced in a combustion chamber into which are introduced combustion air under high pressure and a fuel which may be natural gas. A mixture of combustion air and gas at a very high pressure and temperature, for example 1300° C., containing combustion products such as CO₂, CO and nitrogen oxides is obtained at the outlet of the combustion chamber. A high performance gas turbine of which the design and constituent materials allow operation with a very high temperature gas is used in this case. An installation of this type operates in an open circuit, and the gases which are used to drive the turbine and consist mainly of air are returned to the atmosphere.

In fact, fresh air containing a sufficiently large proportion of oxygen to allow combustion of the natural gas has to be introduced into the combustion chamber.

Before being discharged to the atmosphere, the high temperature gas issuing from the gas turbine may be conveyed into a, or in succession into a plurality of steam generator(s) or heat exchanger(s) supplied with water, wet steam or supercritical water to produce dry steam for driving one or more steam turbines.

Three turbine stages at high, medium and low pressure placed on the same shaft as the gas turbine are generally used to drive the electric generator. The steam at the outlet of the low pressure steam turbine is conveyed into a condenser, and the condensed water is recycled into the secondary portion of a steam generator providing steam to the high pressure stage.

An installation of this type has the advantage of containing only components of the conventional type such as a gas turbine driven by a combustion gas mainly containing nitrogen and combustion gases and steam turbines, being components which are quite conventional in electricity producing installations.

However, the energy yield of these installations is not optimal in so far as the gases discharged to the atmosphere still contain a significant amount of heat which is not utilised.

In addition, it seems difficult to adapt this open cycle configuration when the heat is produced in a high temperature nuclear reactor core.

GB-2.050.679 proposes a process and installation for utilising heat generated by a helium-cooled nuclear reactor, employing a secondary circuit disposed at the exterior of the nuclear reactor security building in which there is circulated a gaseous mixture consisting of helium and nitrogen which is heated by the cooling helium from the nuclear reactor. A gas turbine, coolers and compressors in which the secondary gas circulates in a closed circuit are disposed on the secondary circuit.

The object of the invention is therefore to propose a method for producing electricity from the heat produced in the core of at least one high temperature nuclear reactor, which involves circulating a first coolant heat-exchange gas in contact with the core of the nuclear reactor in a closed circuit, heating a second heat-exchange gas by heat-exchange with the first heat-exchange gas and using the second heat-exchange gas heated by the first heat-exchange gas to drive at least one gas turbine coupled to an electric generator, this method resulting in a very good energy yield and allowing use of conventional components which do not require sophisticated design engineering.

The first exchange gas consists mainly of helium, the second exchange gas contains substantially 50 to 70% by volume of helium and 50 to 30% by volume of nitrogen, in that the second heat-exchange gas is circulated in a closed circuit so that the second heat-exchange gas heated by the first heat-exchange gas drives the at least one gas turbine and in that at least a first portion of the heat from the second exchange gas which has passed through the gas turbine is recovered in order to heat and vaporise water in at least one steam generator so as to produce steam for driving at least one steam turbine coupled to the electric generator.

It may be advantageous to recover at least a portion of the second heat-exchange fluid, for example at the outlet of the primary portion of the steam generator or the gas generator, in order to supply heat to an auxiliary installation such as an urban heating system or a seawater desalination plant or any other industrial utilisation of heat.

In certain cases, the use of a fraction of the second heat-exchange fluid heated to the temperature of the first fluid forming the coolant fluid of the nuclear reactor may be considered to fulfil a function necessitating a very high temperature gas such as hydrogen production.

The invention also relates to an electricity-producing installation employing the method according to the invention.

To assist understanding of the invention, an embodiment of an electricity and heat producing installation employing the method according to the invention will now be described by way of example with reference to the accompanying drawings, in which:

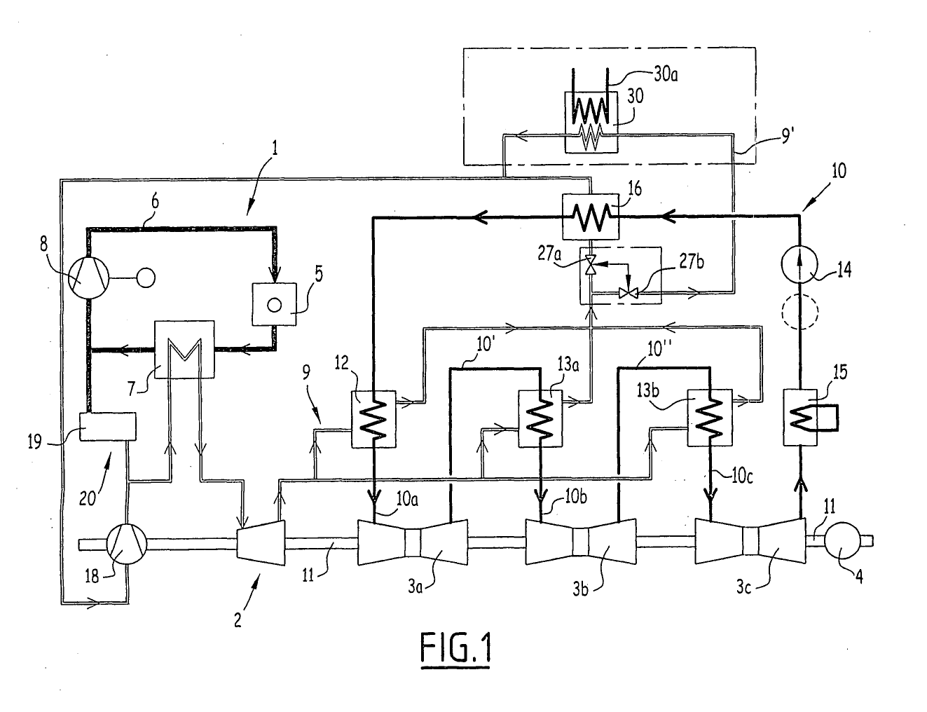

FIG. 1 is a general schematic view of the entire installation according to the invention.

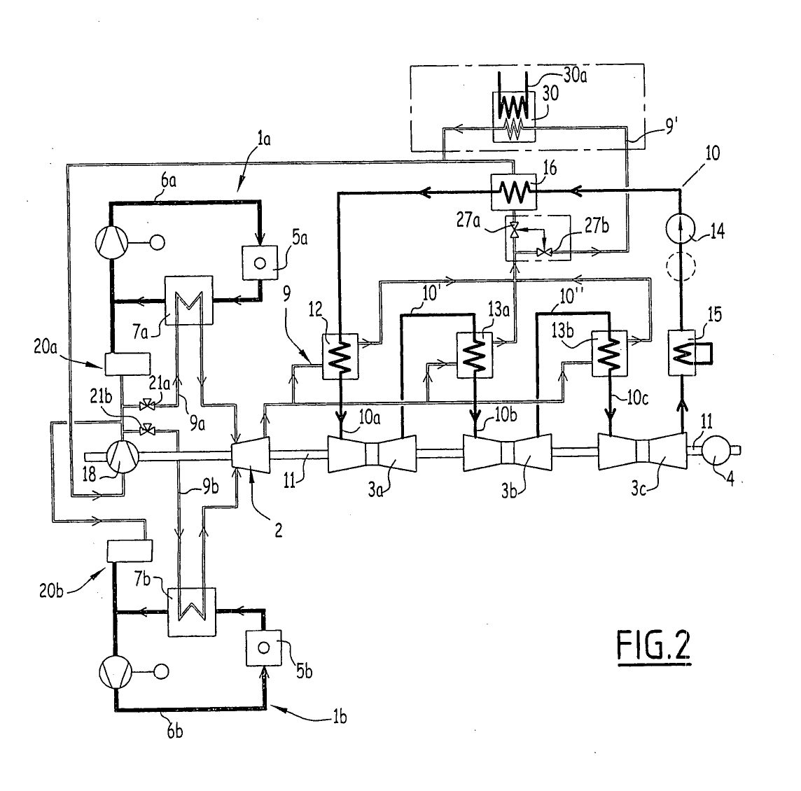

FIG. 2 is a general schematic view of the entire installation according to a variation comprising two nuclear reactors.

The installation shown in FIG. 1 mainly comprises a high temperature nuclear reactor generally designated by reference numeral 1, a gas turbine 2, three steam turbines 3a, 3b, 3c and an electric generator 4 consisting of an alternator of which the rotor is mounted on a drive shaft 11 common to the gas turbine 2 and to the three steam turbine stages 3a, 3b and 3c.

The nuclear reactor 1 comprises a core 5 producing heat of which the temperature during operation may be approximately 850° C., and this temperature may be substantially higher and, for example, approximately 950° C. in the case of certain types of high temperature nuclear reactor.

The nuclear reactor 1 also comprises a primary circuit 6 which is a closed circuit in which the coolant helium circulates. An intermediate exchanger 7 for heating a secondary heat-exchange gas and for cooling the helium circulating in the primary circuit and forming the coolant of the nuclear reactor is placed on the primary circuit 6 of the nuclear reactor 1.

A pump 8 for circulating the helium in the primary circuit and slightly compressing the helium introduced into the nuclear reactor core 5 to a pressure of approximately 70 bar is also placed on the primary circuit 6 of the nuclear reactor. The helium forming the coolant fluid of the nuclear reactor experiences only a slight drop in pressure as it passes through the intermediate exchanger 7, so it is possible to use a helium circulating pump which brings about only a slight increase in pressure on discharge. A pump of this type corresponds to mainstream technology.

The intermediate exchanger 7 performs heat-exchange between the primary fluid formed by the helium issuing from the reactor core 5 at a temperature of approximately 850° C. which is the temperature of the core and a secondary heat-exchange gas circulated in a secondary circuit designated generally by reference numeral 9.

According to the invention, the secondary heat-exchange gas circulating in the circuit 9 is formed mainly by a mixture of helium and nitrogen or else a mixture of helium and air. However, it is preferable to use a mixture containing practically only helium and nitrogen so as to eliminate or limit oxidation phenomena in the secondary circuit. The intermediate exchanger has characteristics suitable for heat-exchange between the first and second exchange gas under the temperature and pressure conditions resulting from operation of the installation.

The second exchange gas forming the secondary fluid of the installation generally contains substantially 50 to 70% by volume of helium and 50 to 30% by volume of nitrogen.

The secondary circuit in which the mixture of helium and nitrogen circulates is a completely closed circuit, the second exchange gas being reintroduced into the intermediate exchanger and heated by the first exchange gas formed by the coolant helium from the nuclear reactor after having driven the gas turbine 2 and heated and vaporised fluid such as the water circulating in a tertiary circuit 10, and performed other heating functions which will be described hereinafter. The mixture of helium and nitrogen of the second exchange gas is typically introduced into the intermediate exchanger at a temperature of 300° C. and heated to a temperature of approximately 800° C. by the first exchange gas formed by the coolant helium which enters the intermediate exchanger 7 at a temperature of approximately 850° C. and issues from the intermediate exchanger at a temperature of approximately 350° C.

As will be explained hereinafter, the intermediate exchanger 7 operates with virtually equal pressure, the first exchange gas and the second exchange gas being at the same pressure which may be, for example, approximately 70 bar at the inlet and at the outlet of the intermediate exchanger 7.

The second exchange gas at a temperature of approximately 800° C. and at a pressure of approximately 70 bar at the outlet of the intermediate exchanger is conveyed to the inlet of the gas turbine 2 of which the second exchange gas or secondary gas performs rotation. The rotating part of the gas turbine 2 is preferably fixed on the rotating shaft 11, common to the gas turbine 2 and to three steam turbines 3a, 3b, 3c which are thus coupled to the rotor of the alternator 4. The rotating part of the gas turbine may also be fixed on a first drive shaft for an alternator and the steam turbines (generally two or three turbines) on a second drive shaft for an alternator.

At the outlet of the gas turbine 2, the second heat-exchange gas has a temperature of approximately 600° C. and a maximum pressure of 50 bar, the pressure preferably being approximately 20 to 30 bar.

To assist understanding of FIG. 1, the primary circuit 6 in which there circulates the helium which is the coolant fluid for the nuclear reactor 5 has been shown in a solid line, the conduits of the secondary circuit 9 in which there circulates the mixture of helium and nitrogen by a double line and the tertiary circuit 10 in which there circulate water and steam forming the tertiary fluid of the installation in the form of a solid line which is thinner than the solid line used to show the primary circuit 6.

At the outlet of the gas turbine 2, the second exchange fluid of which the temperature is approximately 600° C. is recovered by a pipe of the secondary circuit 9 and arrives at the steam generator 12 and at the heat exchanger heaters 13a and 13b connected to the portions of the tertiary circuit 10 of the installation in which water and steam circulate.

The pipe of the secondary circuit 9 connected to the outlet of the gas turbine 2 has a junction connected to a primary portion of the steam generator 12 of which the secondary portion shown schematically in the form of a coil is supplied with water to be heated and vaporised. A second bypass of the turbine outlet pipe is connected by a respective second and third junction to respective heat exchanger heaters 13a and 13b.

The junctions of the pipe connected to the outlet of the gas turbine 2 are produced in such a way that the primary portion of the steam generator 12 receives up to 80% by volume of the second heat-exchange gas and the heat exchangers 13a and 13b, 20% by volume of the second heat-exchange gas.

Preferably, in the case (shown in the figure) of an installation comprising three steam turbine stages, the first stage receives about 74% of the exchange gas and the two following stages each receive about 13%, by volume. In the case of an installation comprising only two steam turbine stages, the first stage may preferably receive 70% by volume of the second exchange gas and the second stage 30% by volume.

A first portion of the heat from the second exchange gas recovered at the outlet of the gas turbine is thus utilised in the tertiary circuit to produce steam and drive steam turbines.

The tertiary circuit 10 comprises a main portion connected, on the one hand, to the inlet of the secondary portion of the steam generator 12 and, on the other hand, to the outlet of a condenser 15 which is in turn connected to the outlet of the low pressure turbine 3c for condensing the wet steam arriving at the outlet of the turbine 3c. At least one pump 14 circulates water in the main portion of the tertiary circuit of water and steam 10 so that the water extracted from the condenser 15 and originating from condensation of the steam from the turbine 3c is conveyed to the inlet of the secondary portion of the steam generator 12.

An exchange of heat between the second exchange gas at a temperature capable of varying between 550 and 700° C. of the secondary circuit 9 and arriving at the inlet of the primary portion of the steam generator with the water supplying the secondary portion is performed inside the steam generator 12 so that a dry steam at a temperature of 500° C. to 600° C. is obtained at the outlet of the steam generator. The dry steam is conveyed through a pipe 10a into the inlet portion of the steam turbine at high pressure 3a.

Wet steam is recovered at the outlet of the high pressure turbine 3a through a first intermediate conduit 10′ of the tertiary circuit 10 and is conveyed to the inlet of the heat exchanger heater 13a which receives a throughput of second exchange gas at a temperature of 600° C. The wet steam is thus superheated and dried to obtain dry steam at a temperature between 500° C. and 600° C., for example between 520° C. and 580° C.

The dry steam recovered at the outlet of the heat exchanger heater 13a is conveyed through a pipe 10b into the inlet portion of the medium pressure turbine 3b for driving the turbine. Wet steam is recovered at the outlet of the medium pressure turbine 3b through a second intermediate conduit 10″ of the tertiary circuit 10 and is superheated and dried in a heat exchanger heater 13b by heat-exchange with the second exchange gas of the secondary circuit 9 at a temperature of 550 to 700° C.

Dry steam at a temperature of 500° C. to 600° C. and, for example, between 520° C. and 580° C., is obtained at the outlet of the super heat exchanger 13b and is conveyed through a third dry steam supply pipe 10c to the inlet portion of the low pressure steam turbine 3c for the driving thereof.

As mentioned hereinbefore, the steam is recovered at the outlet of the low pressure steam turbine 3c and is conveyed to the condenser through a pipe of the main portion of the tertiary water and steam circuit 10.

The steam and water recovered at the outlet of the turbine 3c at a temperature of approximately 30° C. to 35° C. and at low pressure is condensed in the condenser in the form of water at a temperature of 25° C. to 30° C. which is recovered by the main portion of the tertiary circuit 10 on which is placed a counter-current heat exchanger 16 of which the primary portion receives, at the inlet, the second heat-exchange gas circulating in the secondary circuit 9 extracted at the outlet of the steam generator 12 and the exchanger heaters 13a and 13b through pipes of the secondary circuit which are connected to a common pipe for supplying the inlet of the primary portion of the heat exchanger 16.

The second exchange gas of the secondary circuit arriving at the inlet of the primary portion of the heat exchanger 16 which is, for example, of the cross-current or counter-current type is formed by a mixture of gas from the secondary circuit originating from the respective steam generator 12 and heat exchangers 13a and 13b of which the temperature ranges from 160° C. to 300° C.

The water at a temperature of approximately 30° C., of which the pressure may be raised to a high level by the pump 14 arriving in the secondary portion of the exchanger 16 is heated to a temperature of approximately 200° C. to 250° C. by heat-exchange with the secondary gas conveyed to the inlet of the heat exchanger 16.

The heated water which is brought to pressure and may be in the supercritical state is conveyed to the inlet of the secondary portion of the steam generator 12 and vaporised and superheated. The tertiary circuit containing the steam generator 12, the steam turbines 3a, 3b and 3c and the heat exchanger heaters 13a, 13b therefore operates in a closed circuit.

The second heat-exchange gas of the secondary circuit 9 recovered at the outlet of the counter-current heat exchanger 16 is returned through a pipe of the secondary circuit into the secondary portion of the intermediate heat exchanger 7 after passing through a compressor 18 placed on the return conduit of the secondary circuit toward the intermediate heat exchanger 7. The compressor 18 enables the pressure of the exchange fluid of the secondary circuit to be raised to a level substantially equal to the pressure level in the primary circuit 1, in other words to approximately 70 bar.

Owing to the pressure of the secondary exchange fluid recovered at the outlet of the heat exchanger 16, a compressor having a compression ratio of 1.5 to 3 may be used.

The compressor 18 comprises a rotating part which may be mounted on the shaft 11 common to the gas turbine 2, the steam turbines 3a, 3b and 3c and the rotor of the alternator 4.

The gas turbine 2 and the steam turbines 3a, 3b and 3c, which are all mounted on the shaft 11 (or possibly on a first and second shaft, as described hereinbefore) merely drive the compressor 18 in addition to driving the rotor of the alternator 4. The energy extracted by the compressor 18 for compressing the secondary exchange fluid with a compression ratio of 1.5 to 3 represents a small proportion of the energy supplied by the gas turbine and the steam turbines so the energy received by the alternator 4 is only slightly lower than the total energy supplied by the installation.

The second heat-exchange gas of the secondary circuit is also heated by the compressor to a temperature of approximately 300° C. before it enters the intermediate exchanger 7. As explained hereinbefore, the second exchange gas formed by a mixture of helium and nitrogen is heated inside the intermediate exchanger 7 to a temperature of approximately 800° C., the pressure of the secondary exchange gas being approximately 70 bar.

It is particularly advantageous to produce the intermediate heat exchanger 7 in the form of a counter-current plate exchanger. A plate exchanger of this type may be produced so as to have a very good coefficient of exchange since the first heat-exchange gas is formed by helium and the second heat-exchange gas contains large proportions of helium. The exchange coefficient of these gases is very favourable. A very good yield of the plate exchanger is thus obtained.

Preferably, the plate exchanger is produced in modular form and comprises a plurality of units placed in parallel and each receiving an elementary throughput of primary fluid and secondary fluid.

One of the drawbacks of a plate exchanger is that it withstands only slight pressure differences between the primary fluid and the secondary fluid. When a plate exchanger is used as the intermediate exchanger 7, the pressure of the primary fluid at the inlet and at the outlet of the heat exchanger, similarly to the pressure of the secondary fluid at the inlet and at the outlet of the heat exchanger, are substantially equal to one another, these pressures both being, for example, approximately 70 bar.

However, in certain transient phases of operation of the installation or in the case of an incident or an accident, for example the breakage of a pipe, a pressure difference may appear between the primary helium circuit and the secondary circuit in which the mixture of helium and nitrogen is circulating.

To equalise the pressures in the primary portion and in the secondary portion of the plate exchanger 7 during transient phases, a pressure equalising valve 20 is used of which the chamber, inside the valve body 19, comprises two portions separated by pistons of which one is connected to the primary circuit and the other to the secondary circuit in the region of the pipe for the admission of secondary fluid into the intermediate exchanger.

As shown in FIG. 1, a conduit 9′ of the secondary circuit 9 may be provided which forms a bypass between the return pipe for secondary fluid toward the intermediate exchanger and the conduit for introduction of secondary fluid into the counter-current heat exchanger 16. Control valves 27a and 27b are placed on the bypass conduit and on the conduit for introduction of fluid into the counter-current heat exchanger 16 so as to adjust the throughput passing into the bypass branch 9′ on which is placed a heat exchanger 30 at moderate temperature of which the primary portion receives the secondary fluid extracted by the bypass pipe 9′. This secondary fluid is at a temperature of approximately 200° C., and this enables the temperature of a fluid such as water circulating in the secondary portion 30a of the heat exchanger 30 to be raised to a temperature of approximately 200° C. A second portion of the heat contained in the second exchange fluid, of which a first portion is used at the outlet of the gas turbine into the tertiary water and steam circuit is thus used. The heat exchanger 30 may be a plate exchanger.

The water under pressure at 200° C. obtained in the secondary circuit 30a of the heat exchanger 30 may be used, for example, to supply an urban heating circuit or to provide heat of evaporation to a seawater desalination plant.

Some of the residual heat from the secondary fluid is therefore utilised before being returned to the intermediate exchanger, via the compressor 18. The secondary fluid is at a low temperature at the inlet of the compressor 18; the compressor raises the temperature of the secondary fluid to a temperature of admission of intermediate heat into the exchanger of approximately 300° C.

A very high temperature fluid is required in certain cases for needs such as hydrogen production. A very high temperature fluid of this type may be obtained by extracting some of the secondary fluid at the outlet of the intermediate heat exchanger.

To increase the yield of the electricity producing installation, it is possible to use a plurality of gas turbines placed in series so that each turbine located after a preceding turbine receives the gas originating from the outlet of the preceding turbine after heating of the gas in a portion of the intermediate exchanger. The rotating parts of the successive turbines may be connected to the same drive shaft for an electric generator. The gas used at the inlet of each of the successive gas turbines therefore has a temperature which is substantially constant and equal, for example, to 800° C. and a decreasing pressure. In the case of a plate exchanger produced in modular form, modules or successive sets of modules may be used to heat the various gas fractions recovered at the outlet of the gas turbines and reintroduced into a following turbine.

In addition, to improve operation of the tertiary portion of the installation comprising the tertiary water and steam circuit 10, the steam generator, the heat exchangers and the steam turbines, the pressure of the water supplying the steam generator in the tertiary circuit may be increased to a value which is such that the water is in a supercritical state.

The heat exchanger 30 heating water for an auxiliary function may advantageously be a plate exchanger but this exchanger may also be a tube exchanger.

FIG. 2 shows an installation according to a variation of the invention. Apart from the fact that the installation according to the variation comprises two high temperature nuclear reactors 1a and 1b rather than a single nuclear reactor, it is similar to the installation described with reference to FIG. 2 and comprises a secondary circuit 9 in which an exchange fluid formed by a mixture of helium and nitrogen circulates, a tertiary water and steam circuit 10, a gas turbine 2 and three steam turbines 3a, 3b, 3c as well as a heat exchanger 30 at moderate temperature. Like components in FIG. 1 and FIG. 2 are generally designated by like reference numerals.

The two nuclear reactors 1a and 1b may advantageously be produced in a similar manner and have equal powers. Each of the high temperature nuclear reactors comprises a primary circuit 6a or 6b in which there circulates, when the nuclear reactor is in operation, helium at a high temperature, for example of approximately 850° C., forming the coolant gas of the reactor. An intermediate heat exchanger 7a and 7b is placed on each of the two primary circuits 6a and 6b and exchanges heat between the helium forming the first exchange fluid of the installation and the second exchange fluid circulating in the secondary circuit 9. For this purpose, the primary portion of the exchangers 7a and 7b is connected to the corresponding primary circuit 6a or 6b and the secondary portion of the exchangers 7a and 7b to the secondary circuit via a respective junction 9a or 9b connected to a conduit of the secondary circuit downstream of the compressor 18. The secondary portion of the intermediate exchangers 7a and 7b is supplied with a second cooled exchange fluid at a pressure substantially equal to the pressure of the helium in the primary circuits 6a and 6b of the nuclear reactors 1a and 1b. The second heat exchange fluid is maintained at a pressure substantially equal to the helium pressure of the primary circuits by respective pressure equalising valves 20a and 20b similar to the valve 20 of the installation shown in FIG. 1, each connected to the conduit of the secondary circuit supplying the intermediate exchangers and to the corresponding primary circuit.

A respective valve 21a and 21b for adjusting or stopping the circulation of the second exchange fluid in the corresponding intermediate exchanger is placed on each of the junctions 9a and 9b for supplying an intermediate heat exchanger with secondary exchange fluid. The second exchange fluid heated in the intermediate exchangers is used to drive the gas turbine 2.

If the first and second nuclear reactors 1a and 1b are operating simultaneously, the valves 21a and 21b are in the open position and the second exchange fluid is heated by the two reactors. If one of the nuclear reactors, for example the second reactor 1b, is unavailable, for example in the phase of maintenance reloading or repair work, the second valve 21 is closed and the first valve 21a is open. The installation therefore remains in operation and utilises the heat produced by the first reactor 1a which has remained in operation.

It is therefore unnecessary to stop the installation by providing phases of stoppage of the two reactors at time intervals.

As mentioned hereinbefore, a significant advantage of the method and the device according to the invention is to allow the use of conventional components in the case of energy-producing installations such as electric energy-producing installations, for example gas turbines operating with a gas having thermodynamic characteristics close to air, compressors having low compression ratios and conventional steam turbines.

The method and device according to the invention also afford the advantage of employing a secondary fluid containing a large proportion of helium and which has very good heat-exchange characteristics. In particular, the yield of the steam generator and of the heat exchangers of the tertiary circuit in water is markedly improved. The use of steam turbines allows optimum utilisation of the heat produced by the nuclear reactor.

The invention is not limited to the embodiment described.

The installation may comprise a single nuclear reactor or at least two reactors which may operate simultaneously to supply heat to a secondary fluid formed by helium and nitrogen; one or more nuclear reactors may also be stopped, in which case the installation operates with the reactor or reactors remaining in service.

Auxiliary uses of the heat produced by the nuclear reactor or reactors and transferred to the secondary fluid, which are different from those described, may also be considered.

The invention applies to the use of the heat produced by any high temperature nuclear reactor, in other words of which the core operates at a temperature of at least 800° C.

1. Method for producing electricity from the heat produced in the core (5) of at least one high temperature nuclear reactor (1), which involves circulating a first heat-exchange gas or coolant gas in contact with the core (5) of the nuclear reactor (1) in a closed circuit, heating a second heat-exchange gas by heat-exchange with the first heat-exchange gas and using the second heat-exchange gas heated by the first heat-exchange gas to drive at least one gas turbine (2) coupled to an electric generator (4), characterised in that the first exchange gas consists of helium, in that the second exchange gas contains substantially 50 to 70% by volume of helium and 50 to 30% by volume of nitrogen, in that the second heat-exchange gas is circulated in a closed circuit so that the second heat-exchange gas heated by the first heat-exchange gas drives the at least one gas turbine (2) and in that at least a first portion of the heat from the second exchange gas which has passed through the gas turbine (2) is recovered in order to heat and vaporise water in at least one steam generator (12) so as to produce steam for driving at least one steam turbine (3a, 3b, 3c) coupled to the electric generator (4).

2. Method according to claim 1, characterised in that at least a second portion of the heat from the second exchange fluid is recovered in order to supply heat to an auxiliary installation (30) such as an urban heating system or a seawater desalination plant.

3. Method according to claim 1, characterised in that at least a fraction of the heat from the second heat-exchange gas heated by the first heat-exchange fluid is recovered to fulfill, prior to the driving of the gas turbine (2), a function such as the production of hydrogen which necessitates a very high temperature fluid.

4. Method according to claim 1, characterised in that the second heat-exchange gas is heated by heat-exchange with coolant gas from at least two nuclear reactors (1a, 1b) operating simultaneously and with coolant gas from at least one first nuclear reactor (1a, 1b) from among the at least two nuclear reactors, if at least a second nuclear reactor (1a, 1b) is inoperative.

5. Device for producing electricity from the heat produced in the core (5) of at least one high temperature nuclear reactor (1) comprising a primary circuit (6) in which there circulates a first heat-exchange gas for cooling the core (5) of the reactor, a gas turbine (2) coupled to an electric generator (5) via a shaft (11) and a secondary circuit (9) for circulation of a second heat-exchange gas on which the gas turbine (2) is inserted, characterised in that it also comprises at least one intermediate heat exchanger (7) having a primary portion connected to the primary circuit (6) of the nuclear reactor (1) and a secondary portion connected to the secondary circuit (9) and heating the second exchange gas on the basis of the heat produced in the reactor core by the first heat-exchange gas, and a tertiary circuit (10) for circulation of water and steam, on which is disposed at least one steam generator (12) and at least one steam turbine (3a), the intermediate exchanger (7) and the gas turbine (2) having characteristics adapted to the use of helium as first heat-exchange gas and of a mixture of helium and nitrogen as second heat-exchange gas, and the steam generator (12) comprising a secondary portion connected to the tertiary steam and steam circuit (10) to receive water at the inlet and to provide steam at the outlet to the steam turbine (3a) and a primary portion connected to the secondary circuit (9) to receive the second exchange gas after it issues from the gas turbine (2).

6. Device according to claim 5, characterised in that the tertiary circuit (10) also comprises a first heater exchanger (13a) of which the secondary portion is connected to the outlet of the first steam turbine (3a) forming a high pressure turbine to receive a wet steam and of which the outlet portion is connected to a second steam turbine (3b) or medium pressure turbine, a second heat exchanger (13b) having a second portion connected, via an inlet, to the outlet of the second medium pressure turbine (3b) to receive a wet steam and, at the outlet, to an inlet portion of a third steam turbine (3c) or low pressure turbine of which the outlet portion is connected to the circuit (10) on which a condenser (15) is placed, each of the first and second heat exchanger heaters (13a, 13b) having a primary portion supplied with second exchange gas from bypasses of the secondary circuit (9) to heat and dry the wet steam introduced at the inlet of the second portion of the heat exchanger heater and the tertiary circuit (10) being in a closed circuit which enables the water recovered in the condenser (15) to be conveyed to the inlet of the secondary portion of the steam generator (12).

7. Device according to claim 6, characterised in that a counter-current heat exchanger (16) is disposed on a portion of the tertiary circuit (10) for returning condensed water to the inlet of the secondary portion of the steam generator (12) so that a secondary portion of the heat exchanger (16) receives, at the inlet, water originating from the condenser (15) and, at the outlet, supplies heated water to the steam generator (12), and a primary portion in which there circulates the second heat-exchange gas recovered at the outlet of the primary portion of the steam generator (12) and of the heater exchangers (13a, 13b).

8. Device according to claim 5, characterised in that the intermediate heat exchanger (7) is a plate exchanger.

9. Device according to claim 8, characterised in that the secondary circuit (9) is entirely closed and comprises a compressor (18) for recompressing the second exchange gas to a pressure which is substantially equal to the pressure of the first heat-exchange gas in the primary circuit (6) of the nuclear reactor (1) prior to its reintroduction at the inlet of the secondary portion of the intermediate exchanger (7).

10. Device according to claim 9, characterised in that it also comprises at least one pressure equalising valve (20) connected, on the one hand, to the primary circuit (6) of the nuclear reactor (1) and, on the other hand, to a conduit of the secondary circuit (9) which provides the connection between the outlet of the compressor (18) and the inlet of the secondary portion of the at least one heat exchanger (7) so that the pressure of the first heat-exchange fluid in the primary circuit (6) of the nuclear reactor (1) and the pressure in the secondary portion of the at least one intermediate heat exchanger (7) are continuously equal to one another.

11. Device according to claim 5, characterised in that it also comprises a moderate temperature heat exchanger (30) having a first portion connection to the secondary circuit (9) for circulation of the second exchange fluid in the moderate temperature heat exchanger (30) and a secondary portion in which there circulates a liquid such as water used in an auxiliary installation such as an urban heating circuit or a seawater desalination plant.

12. Device according to claim 11, characterised in that the moderate temperature heat exchanger (30) is disposed on a conduit which bypasses a portion of the secondary circuit (9) and in that on the bypass conduit and on the portion of the secondary circuit on which the bypass conduit is placed there are disposed control valves (27a, 27b) for adjusting the throughput of the second exchange fluid in the portion of the secondary circuit and in the bypass conduit.

13. Device according to claim 5, characterised in that it comprises at least two nuclear reactors (1a, 1b) each having a primary circuit (6a, 6b) in which a coolant gas circulates and at least two intermediate heat exchangers (7a, 7b) each having a primary portion disposed on a respective primary circuit (6a, 6b) of a nuclear reactor (1a, 1b) for receiving the coolant gas from the nuclear reactor (1a, 1b) and a secondary portion disposed on a respective junction (9a, 9b) of a secondary circuit for receiving the second heat-exchange fluid, a stop valve (21a, 21b) being disposed on each of the junctions (9a, 9b).

14. Device according to claim 13, characterised in that a pressure equalising valve (20a, 20b) is connected to each of the junctions (9a, 9b) of the secondary circuit and to each of the primary circuits (6a, 6b) of the nuclear reactors to maintain a pressure of the second exchange gas in the secondary portion of a respective heat exchanger (7a, 7b) substantially equal to a pressure of the coolant gas in the primary portion of the heat exchanger (7a, 7b).
